(19) United States
(12) Patent Application Publication
(10) Pub. No.: US 2014/0022504 A1
(43) Pub. Date: Jan. 23, 2014

(54) Quick Draw and Quick Stow Magnetic Eyeglass Holder

(71) Applicant: William Mehrkam Peterson, Chandler, AZ (US)

(72) Inventor: William Mehrkam Peterson, Chandler, AZ (US)

(21) Appl. No.: 13/944,541

(22) Filed: Jul. 17, 2013

Related U.S. Application Data
(60) Provisional application No. 61/741,438, filed on Jul. 20, 2012.

(51) Int. Cl. G02C 3/00

(52) U.S. Cl. CPC G02C 3/00
USPC 351/155

(57) ABSTRACT

One embodiment of an improved magnetic eyeglasses holder system includes a first magnet which can be substantially permanently attached to an eyeglass temple piece or frame, a second magnet positioned outside an article of clothing, and a third magnet positioned inside the article of clothing, providing a secure grip on the article of clothing. One embodiment includes a kit with heat-shrink-tubing to substantially permanently attach a first magnet to an eyeglass temple piece or frame. Other substantially permanent attachment options are described and shown, too. Sales of kits, for adapting ordinary eyeglasses, can develop and prove the existence of substantial markets for improved magnetic eyeglasses holders and thereby justify the expense of future mass production. Another embodiment, which is mass producible, uses a first magnet that is molded into the eyeglasses. Other embodiments are described and shown. A method for adapting ordinary eyeglasses is included, too.

### CROSS-REFERENCE TO RELATED APPLICATIONS

This application claims the benefit of U.S. Provisional Application No. 61741438 filed Jul. 20, 2012.

Patents, by others, discovered in a recent patent search:

| Ref # | Patent # | Notes | Title |
|---|---|---|---|
| 1. | 7,600,870 | Lenses | Attachable magnetic eyeglass |
| | | | and method of making same |
| 2. | 7,494,217 | Face profile | Magnetic eyeglass holder |
| 3. | 7,296,889 | Clip and 2 magnets | Magnetic eyeglass holder |
| 4. | 7,296,888 | Lenses | Eyeglass appliance, eyeglass |
| | | | component and eyeglass frame |
| 5. | 7,229,171 | 2 center magnets | Removable eyeglass clasp |
| 6. | 7,172,283 | 2 center magnets | Magnetic eyeglass device |
| 7. | 7,140,728 | Lenses | Method of forming magnetic |
| | | | eyeglass appliance |
| 8. | D519,542 | Cord & magnet ends | Magnetic eyeglass retainer |
| 9. | 6,616,274 | Magnets to monitor | Ready reader eyeglasses with |
| | | | magnets recessed into front |
| | | | frame, including carrying case |
| | | | and ferromagnetic strip |
| 10. | 6,412,942 | Lenses | Eyeglass accessory frame, |
| | | | eyeglass |

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Millions of people wear glasses (for reading, distance vision, sun-shading, etc.) and need to put-on and take-off those glasses many times a day. For example, reading glasses may be put-on and taken-off many dozens of times a day. Those people must find a place to put the glasses when not in use. Furthermore, that place should be always secure and conveniently accessible, for fast put-on (“quick draw”) and fast take-off (“quick stow”). Several improvised approaches meet one or two of these requirements, but fail miserably on at least one requirement. Thus there is an unmet need for a quick draw and quick stow eyeglass holder.

As of 2012, you can buy (e.g. on Ebay.com) at least ten differently decorated magnetic eyeglass holders. However, 100% of those holders magnetically hold a “loop”, through which the user must “thread the needle” with one temple piece. This thread the needle task can be frustratingly tedious and slow. This is especially likely when the user is not visually focusing on the loop (e.g. while making eye contact with another person during a conversation). Worse yet, the eyeglasses can be reading glasses which are required before it is possible for him to focus on the loop.

Deficiencies of prior patents (These references are listed in the “Cross-Reference to Related Applications” section above):
Patents Ref-1, Ref-4, Ref-7, Ref-10 describe other magnetic attachments to eyeglasses. However, the object being attached to eyeglasses is one or more lenses. These are not solutions to the needs of quick draw and quick stow (see definitions in the List of Defined Terms section below).
Patent Ref-2 describes a piece of bent metal shaped like the profile of a face used to stick magnetic eyeglasses on a table top. This does not provide quick draw, nor quick stow. For example, when the user is away from the table top, the glasses are not available, for a quick draw.
Patents Ref-3, Ref-5 and Ref-6 describe a two-magnet approach in which both magnets are attached to the middle of the temple pieces, such that the glasses can grip cloth when the folded with cloth between the two magnets (or a metal spring clip). While this approach does avoid the tedious “thread the needle-loop” task, this approach is still impractical for the following reasons. (a). Many shirts and dresses do not have an opening (in which to insert one temple piece) other than a neck opening (which can be very uncomfortable since sharp hinge edges can scratch the neck and chest. (b). If the neck line is the only place available, the glasses will generally stay put without any magnets.
Patent Ref-8, describes a cord with magnetic ends. This does not provide any quicker draw than does just a non-magnetic cord on glasses.
Patent Ref-9, describes glasses with a magnet that can stick to a computer monitor. This does not provide quick draw, nor quick stow.

### BRIEF SUMMARY OF THE INVENTION

Not Applicable. (See the abstract, instead).

### BRIEF DESCRIPTION OF THE SEVERAL VIEWS OF THE DRAWING

FIG. 1A. This drawing shows a person “quick drawing” his or her eyeglasses (removing them from their “stowed” position).

FIG. 1B. This drawing shows a person “quick stowing” his or her eyeglasses (replacing them in their “stowed” position).

FIG. 1C. This drawing shows a person actively moving (e.g. running) while the eyeglasses stay securely stowed.

FIG. 1D. This drawing shows a person, without the present invention, wasting time fishing in a purse or eyeglass case.

FIG. 1E. This drawing shows a person, without the present invention, wasting time, with frustrating attempts to penetrate a loop-type holder.

FIG. 1F. This drawing shows a person, without the present invention, bending down and dropping his or her eyeglasses.

FIG. 1G. This drawing summarizes “quick drawing” and “quick stow” advantages of the present invention.

FIG. 2. This perspective drawing shows a pair of eyeglasses with various regions labeled.

FIG. 3A. This perspective drawing shows a magnified view of region 46 from FIG. 2 with (not-yet-shrunk) heat-shrink tubing and magnet#1.

FIG. 3B. This perspective drawing shows a magnified view of region 46 from FIG. 2, with (already-shrunk) heat-shrink tubing and magnet#1.

FIG. 3C. This perspective drawing shows a magnified view of region 48 from FIG. 2, with (not-yet-shrunk) heat-shrink tubing and magnet#1.

FIG. 3D. This perspective drawing shows a magnified region 48 from FIG. 2, with (already-shrunk) heat-shrink tubing and magnet#1

FIG. 4. This perspective drawing shows an item of clothing (e.g. a shirt) and three preferred locations for magnet#2 (outside the shirt) and magnet #2 (inside the shirt).

FIG. 5. This perspective drawing shows a close-up-view of a section of an item of clothing (e.g. a shirt) with magnet#2 (outside the shirt) and magnet #2 (inside the shirt).

FIG. 6 is a drawing showing three views (top, end, & side views) of one preferred shape of magnet#1 with edges that can be captive in a magnet-wrapper.

FIG. 7 is a drawing showing three views (top, end, & side views) of one preferred shape of magnet#1 embedded in one embodiment of a magnet-wrapper with a retaining pin 141.

FIG. 8 is a drawing showing three views (top, end, & side views) of one preferred shape of magnet#1 embedded in one embodiment of a magnet-wrapper that can be snapped or clipped onto eyeglass temple pieces.

FIG. 9 is a drawing showing three views (top, end, & side views) of one preferred shape of magnet#1 embedded in one embodiment of a magnet-wrapper that can be snapped or clipped onto eyeglass temple pieces and further secured by shim 182.

FIG. 10 is a drawing showing three views (top, end, & side views) of one preferred shape of magnet#1.

FIG. 11 is a drawing showing three views (top, end, & side views) of one preferred shape of magnet#1 molded into a plastic magnet-wrapper that can be otherwise attached to an eyeglass temple piece region.

FIG. 12 is a drawing showing three views (top, end, & side views) of one preferred shape of magnet#1 molded into a plastic magnet-wrapper that can be snapped-onto an eyeglass temple piece region. (The variations shown in FIGS. 7, 8 and 9 can be applied to this molded-on version, too.)

FIG. 13 is a drawing showing a top view of the hinge region of a pair of eyeglasses.

FIG. 14 is a drawing showing a top view of the metal (or plastic) bracket that can be screwed into the threaded hinge hole of a pair of eyeglasses.

FIG. 15 (identical to FIG. 6) is a drawing showing three views (top, end, & side views) of one preferred shape of magnet#1 with edges that can be captive in the magnet-wrapper which is shown in FIG. 14.

FIG. 16 is an illustration showing safety warnings that should accompany retail sales of the present invention.

FIG. 17 is an illustration showing how to more easily separate strong magnets (e.g. magnet#2 from magnet#3).

FIG. 18 is a perspective drawing showing a means and method of displaying the improved eyeglass holder (at retail point-of-sale).

FIG. 19 is a perspective drawing showing a means and method of displaying the improved eyeglass holder along with one or more mirrors.

FIG. 20 is a perspective drawing showing one embodiment of a display board for selling the improved eyeglass holder.

FIG. 21a is a perspective drawing of a pair of eyeglasses showing another magnet attachment approach. A cross section view plane is shown.

FIG. 21b is a cross section drawing the temple piece showing a molded-in magnet.

FIG. 21c is a cross section drawing the temple piece showing a molded-in cavity, that can hold a low cost plastic plug or a magnet.

FIG. 22a is a side view and end view of a section of heat-shrink tubing with removed sharp-irritating-edges due to the beveled edges.

FIG. 22b is another side view and end view of a section of heat-shrink tubing with removed sharp-irritating-edges due to the beveled edges.

FIG. 23a is a perspective view of a pair of glasses (e.g. sunglasses) showing a region 246 between hinge and lens.

FIG. 23b is a perspective view of region 246 with magnet 261 and not-yet-shrunk heat-shrink-tubing 263.

FIG. 23c is a perspective view of region 246 with magnet 261 and already-shrunk heat-shrink-tubing 263.

FIG. 23d is a perspective view of a pair of glasses 273 with heats-shrink (or otherwise bonded) magnet 272 which is hanging by stronger magnet 271 which is magnetically (or otherwise) bonded to iron-containing object 270 (such as a screw or sheet metal).

### DETAILED DESCRIPTION OF THE INVENTION

In order to more accurately and concisely describe the present invention, the following terms are first listed, then are defined below:

### List of Defined Terms

article of clothing (e.g. shirt)
bracket
cloth-gripping-strength
damaged eyeglasses
eyeglass
eyeglass hinge
eyeglass hinge segment
eyeglasses weight
heat-shrink-tubing
hinge-closing-spring-strength
loop-based holders
magnet-wrapper
magnet1
magnet2
magnet3
quick draw
quick stow
self-aligning
self-polarizing
self-centering of magnets
self-pole-flipping of magnets
semi-permanent magnet fastener
semi-permanently fastened
shirt
slow-frustrating-draw
slow-frustrating-stow
stowed location
temple piece
temple piece end segment
temple piece end segment
temple piece tip
temporarily magnetically fastened
user
variable magnetic gap
widest segment point

### DEFINITIONS OF TERMS

Note: Previously defined terms are italicized in the definitions below and other sections of this application.

article of clothing is generally defined as commonly defined in an ordinary dictionary.

bracket is defined as a way of fastening or joining a plurality of objects.

cloth-gripping-strength is defined as the magnitude of net force that keeps an object from sliding (generally down, generally due to gravity), along a cloth object.

damaged eyeglasses is generally defined as eyeglasses with significantly compromised optical or aesthetic properties, generally due to being dropped to the ground or floor.

eyeglass is defined as an apparatus with at least one lens for improving vision, or aesthetic style, which is mechanically supported by at least one ear and a nose.

eyeglass hinge is defined as a movable joint that allows the eyeglasses to fold into a more compact configuration. Eyeglass hinges are typically located near the outside of each lens, and generally attached to an eyeglass frame that generally holds the eyeglass lenses.

eyeglass hinge segment is defined as the section of eyeglasses (frame/temple piece) that is located approximately a quarter-inch from an eyeglass hinge.

eyeglasses weight is defined as total weight of eyeglasses, in grams.

Heat-shrink-tubing is defined as tubing that can shrink when heated, it can have adhesive on the interior surface too. The optional adhesive can be ordinary or heat activated.

Hinge-closing-spring-strength is defined as the spring-powered force that the eyeglass hinge can exert to keep the eyeglasses folded in the more compact configuration.

loop-based holders is defined as eyeglass holders that require eyeglass temple piece to be threaded into a loop-of-material, in order to hold the eyeglasses.

magnet-wrapper is defined as an object that substantially surrounds a magnet in order to mechanically hold the magnet. Often the wrapper is fastened to something else.

magnet1 is defined as a strong permanent magnet (typically a Neodymium magnet) that can be semi-permanently fastened to a pair of eyeglasses without adding excessive mass, volume, or otherwise ugly or distracting appearances. Here, semi-permanently fastened means, fastened for months, rather than for a few minutes or hours.

magnet2 is defined as a strong permanent magnet (typically a Neodymium magnet) that can be temporarily magnetically fastened to Magnet1.

magnet3 is defined as a strong permanent magnet (typically a Neodymium magnet) that can be temporarily magnetically fastened to Magnet2, with a section of cloth securely clamped between Magnet2 and Magnet3. Magnet2 and Magnet3 can be identical in shape, size and strength.

Quick draw is defined as the relatively rapid process of fetching a pair of eyeglasses from their stowed location in preparation to use the glasses.

Quick stow is defined as the relatively rapid process of putting away a pair of eyeglasses into their stowed location.

self-aligning is defined as a property of a plurality of magnets such that they tend to orient themselves in geometric alignment, due to attractive magnetic forces.

self-polarizing is defined as a property of a plurality of magnets such that they tend to orient themselves North-near-South alignment, due to magnetic forces.

Self-centering of magnets is defined as the effect of magnetic forces between two, or more, magnets that tends to “find” and attract each other.

Self-pole-flipping of magnets is defined as the effect of magnetic forces between two, or more, magnets such that they automatically find their strongest magnetic bond. That is, they will sometimes physically flip over one magnet such that the resulting nearest large magnet faces are of opposite polarity (providing the strongest magnetic bond). (Note that magnets can get stuck in local energy minima, which do not provide the strongest magnetic bond. To avoid this, the magnets need to be given the freedom and space to find their global energy minimum).

semi-permanent magnet fastener is defined as the way of semi permanently fastening magnet1 to a pair of eyeglasses. An example of a semi-permanent magnet fastener is a segment of shrunk heat-shrink-tubing, after placing it over magnet1 and over the temple piece end segment containing a widest segment point. Here, semi-permanently fastened means, fastened for months, rather than for a few minutes or hours.

shirt is generally defined as an article of clothing, or specifically corresponding to the common meaning of “shirt.”

slow-frustrating-stow is generally defined as an undesirable process of putting away eyeglasses for temporary storage.

slow-frustrating-draw is generally defined as an undesirable process of fetching eyeglasses from some stowed location.

Stowed location is defined as the location where a pair of eyeglasses are placed when not being used.

temple piece is defined as that portion of a pair of eyeglasses that extends from the eyeglass hinge, or where a hinge would normally be located, toward one ear (the associated ear). There are typically two temple pieces on each pair of eyeglasses, one for each associated ear.

temple piece end segment is defined as that section of the temple piece that extends about one inch from the temple piece tip. Very often this temple piece end segment is contains a widest segment point, which can be used to secure a semi-permanent magnet fastener, such as heat-shrink-tubing, to the temple piece.

temple piece tip is defined as the very end of the temple piece, nearest the associated ear.

temporarily magnetically fastened is defined as the joining of two objects by an attractive magnetic force which can be un joined by pulling apart those objects.

User is defined the person using or wearing the Eyeglasses that are, or are to be, magnetically held.

variable magnetic gap is defined as an adjustable final (equilibrium) separation of magnet#1 and magnet#2. For example, two wedges can be slid closer together to increase the gap.

widest segment point is defined as that location along a temple piece (generally a temple piece end segment) that is dimensionally wider than any other nearby location along the temple piece (generally a temple piece end segment).

### DETAILED DESCRIPTION OF THE INVENTION

### Continued

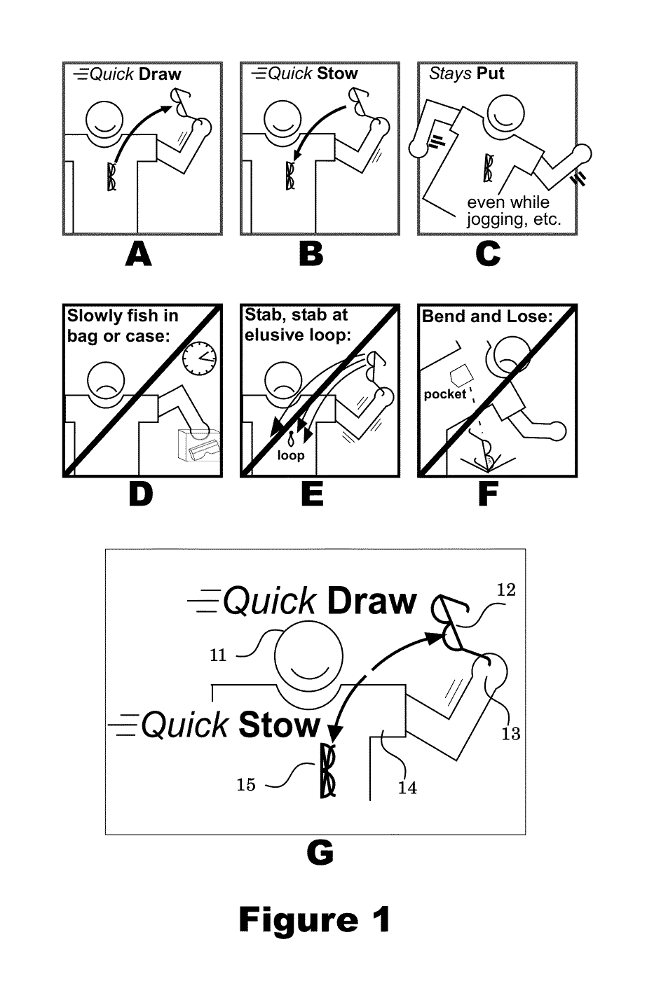

FIGS. 1A, 1B and 1C show some of the advantages of the preferred embodiment of the present invention. That is, eyeglasses can be conveniently and quickly drawn from their stowed location for use on the user's face. Likewise, the eyeglasses can be quickly stowed by simply placing them near their magnetic attraction site, which is easily applied to articles of clothing (such as a shirt, for example). The magnetic force of attraction is strong enough to securely hold the eyeglasses when the user is actively moving (e.g. running, walking, etc.) yet not so strong that it becomes a chore to quick draw the eyeglasses from their stowed location.

FIGS. 1D, 1E and 1F show some of the deficiencies of the prior art in eyeglass holders. That is, eyeglass cases, purses and fanny packs often require the user to waste time “fishing” though the contents. “Prior art” magnetic eyeglass holders use a loop of cord, wire, or the like, that is intended to hold eyeglasses by threading a temple piece through the loop. However, using such loop-based holders can be frustratingly slow and inconvenient. For example, the temple piece does not easily find the open loop, especially when vision is needed to find the loop center, resulting in a slow-frustrating-stow. (Remember, the user has to remove his glasses to stab at the loop, which often restricts focusing ability). For another example, often the eyeglasses hinge will get caught on the loop, resulting a slow-frustrating-draw. For another example, occasionally, the temple piece can slip through the loop and crash to the ground, resulting a damaged eyeglasses.

FIG. 1G, combines some advantages of the preferred embodiment of the present invention, showing eyeglasses in the quick stow position 15 on an article of clothing (e.g. shirt) 14. The same eyeglasses, at another point in time, are shown in a quick draw position 12. (The user's head is represented by item 11).

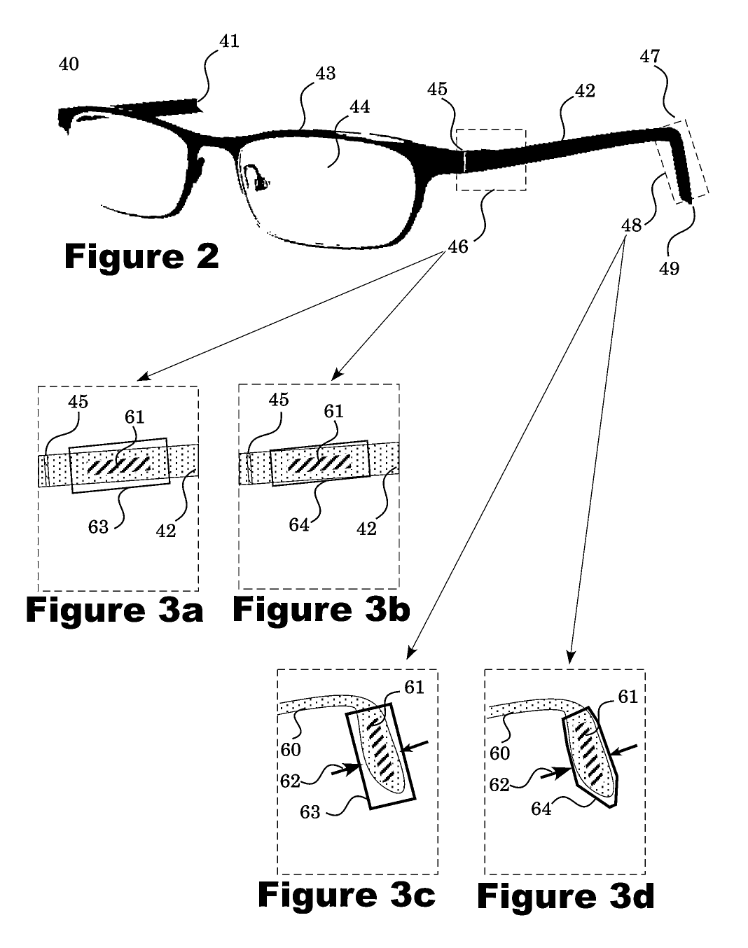

FIG. 2, shows a pair of substantially representative eyeglasses 40, with eyeglass hinge 45, temple piece 42, temple piece end segment 47, temple piece tip 49 and eyeglass-hinge-segment 46, as well as lens 44, frame 43 and other temple piece 41.

FIG. 3. The eyeglass-hinge-segment 46 is shown in magnified detail in FIG. 3a and FIG. 3b. Item 61 is a strong magnet that we will call Magent#1, in order to clearly distinguish it from the other two magnets magnet#2 and magnet#3. The region 63 represents a section of heat-shrink-tubing before it has been heated (before it has been shrunk). In FIG. 3B, the region 64 represents a section of heat-shrink-tubing after it has been heated (after it has been shrunk).

It should be noted that this heat-shrink-tubing must withstand significantly strong forces that try to separate magnet#1 from the eyeglasses, especially when moving actively (e.g. running). Yet, the heat-shrink-tubing must be thin enough to allow minimal magnetic field reduction due to the resulting gap between magnet#1 and magnet#2. Aesthetically, the heat-shrink-tubing should be nearly invisible (e.g. hidden behind the user's ear), not colored (e.g. clear), or colored to please the user.

The temple piece end segment 47 is shown in magnified detail in FIG. 3c and FIG. 3d. Item 61 is a strong magnet that we will call Magent#1, in order to clearly distinguish it from the other two magnets magnet#2 and magnet#3. The region 63 represents a section of heat-shrink-tubing before it has been heated (before it has been shrunk). In FIG. 3d, the region 64 represents a section of heat-shrink-tubing after it has been heated (after it has been shrunk). Magnet#1 generally has a mild adhesive and liner to make easier the application of heat-shrink-tubing. The heat-shrink-tubing can be shrunk by using a hairdryer, heat gun, or other source of heat.

Note that magnet#1 is intended to be attached at the eyeglass-hinge-segment 46—or—temple piece end segment 47, but not both, for a give pair of eyeglasses.

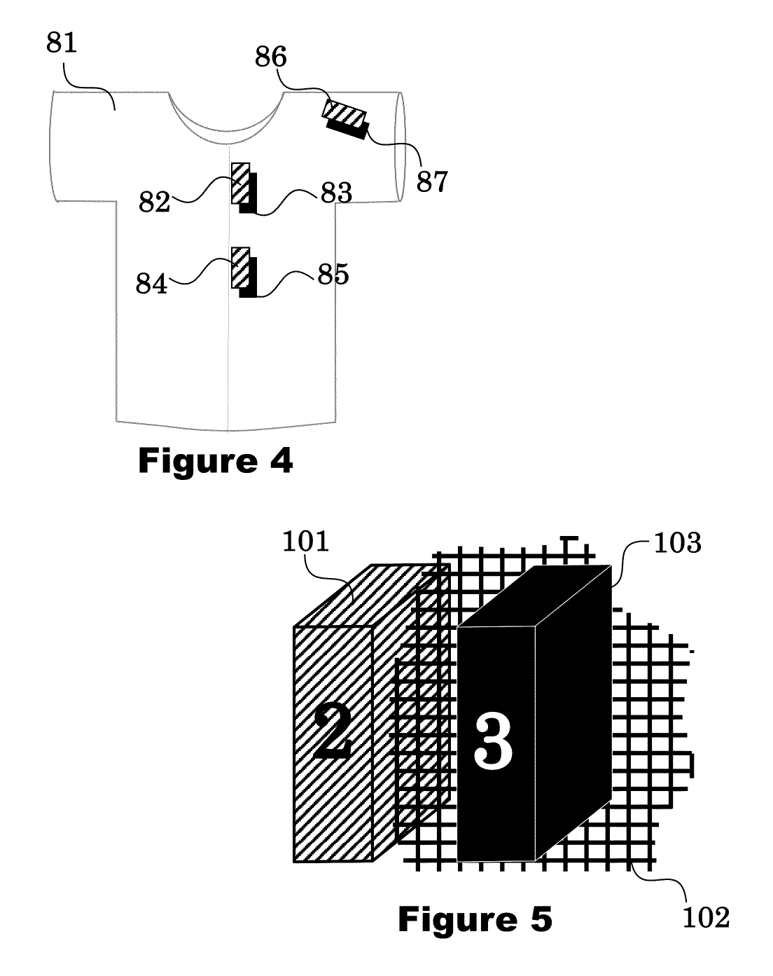

FIG. 4 is a perspective drawing shows an item of clothing (e.g. a shirt, dress, blouse, etc.) 81 and three preferred locations for magnet#2 (outside the shirt) and magnet #3 (inside the shirt). Only one inside location and one corresponding outside location are used at any given time. The user can choose one of the three locations based on personal preference (convenience, style, etc.). Magnets at location 82/83 can be hidden (if desired) by the button-up flap of cloth on many dress shirts. Likewise for magnets at location 84/85, that may be easier to reach for some people (i.e. with longer or shorter arms or mobility issues). Magnets at location 86/87 have the advantage that common seatbelts and aircraft harness straps don't interfere with the eyeglasses hanging there.

FIG. 5 is a perspective drawing showing a close-up-view of a section of an item of clothing 102 (e.g. of a shirt) magnet#2 (101 outside the shirt) and magnet #3 (103 inside the shirt). It should be noted that the surface roughness of magnet#2 and/or magnet#3 can affect the cloth-gripping-strength. An optimum surface treatment (and magnetic field strength) will not cut or tear the shirt, will slide for minor re-positioning, be aesthetically pleasing, easily cleaned (if necessary). Also somewhat rounded edges and corners should be used for magnets #2 and #3. The cloth 102 cannot exceed a reasonable thickness, without compromising the cloth-gripping-strength.

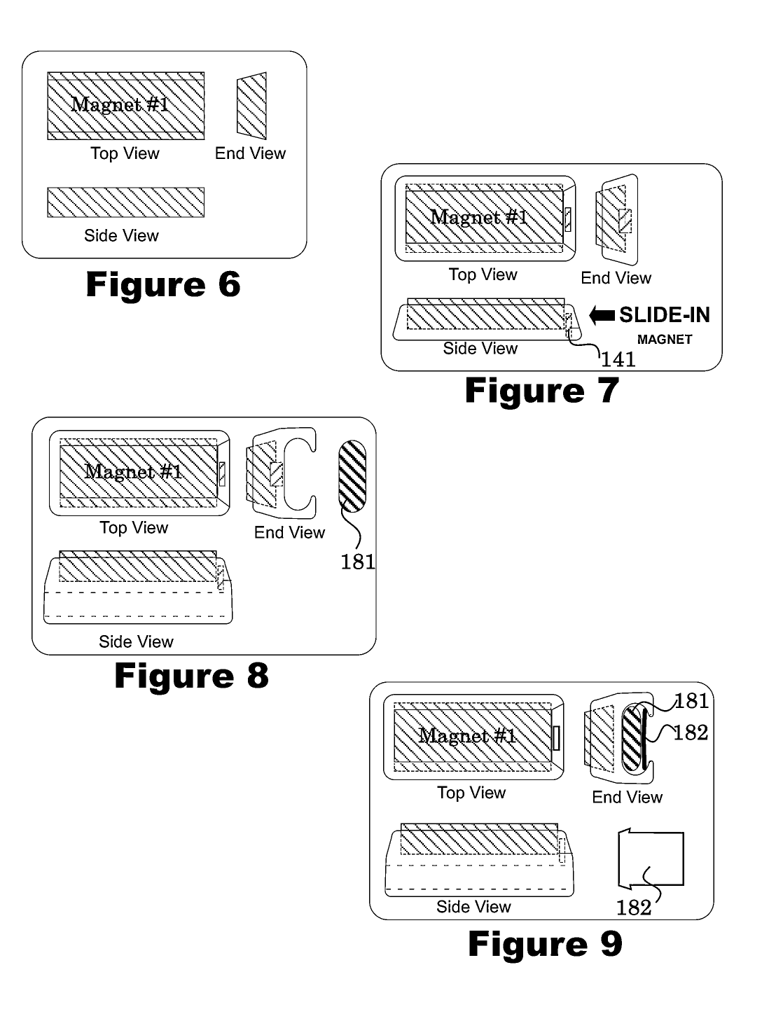

FIG. 6 is a drawing showing three views (top, end, & side views) of one preferred shape of magnet#1 with edges that can be captive in a magnet-wrapper. The sloped (e.g. beveled) edges can be easily manufactured in existing commercial neodymium magnet manufacturing processes (even by extrusion). Yet, the sloped edges can be securely gripped by simple fasteners to attach to an eyeglass temple piece segment. One such fastener can be called a magnet-wrapper. Three such magnet-wrappers are shown in FIGS. 7, 8, and 9.

Notice that a surface of magnet#1 typically protrudes through, or is substantially flush with, a surface of each magnet-wrapper. This allows for a strong magnetic attractive force (between magnet#1 and magnet#2), by keeping the magnetic gap small.

FIG. 7 is a drawing showing three views (top, end, & side views) of one preferred shape of magnet#1 embedded in one embodiment of a magnet-wrapper with a retaining pin 141. The pin can hold-in the magnet. This version can be assembled “in the field” (outside the factory). The large flat surface can hold an adhesive.

FIG. 8 is a drawing showing three views (top, end, & side views) of one preferred shape of magnet#1 embedded in one embodiment of a magnet-wrapper that can be snapped or clipped onto eyeglass temple pieces. This can reduce or eliminate the need for chemical bonding (e.g. glue) to the chosen temple piece segment.

This type of magnet-wrapper can be especially easy for the user to attach himself/herself.

FIG. 9 is a drawing showing three views (top, end, & side views) of one preferred shape of magnet#1 embedded in one embodiment of a magnet-wrapper that can be snapped or clipped onto eyeglass temple pieces and further secured by sliding in retaining shim 182 to press against the temple piece segment 181 and the magnet-wrapper. This too, can reduce or eliminate the need for chemical bonding (e.g. glue) to the chosen temple piece segment.

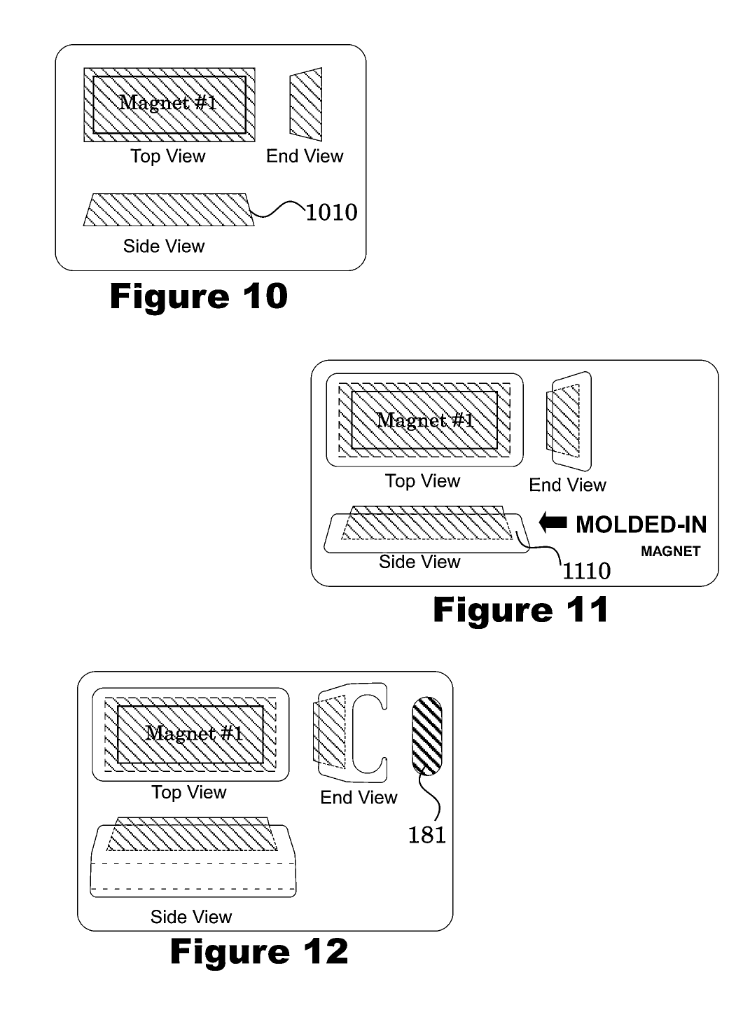

FIG. 10 is a drawing showing three views (top, end, & side views) of one preferred shape of magnet#1. Note the sloped ends (which probably require molding as opposed to pure extrusion). It is used in FIGS. 11 and 12. This shape, when over-molded, can grip a little better than that in FIG. 6.

FIG. 11 is a drawing showing three views (top, end, & side views) of one preferred shape of magnet#1 molded into a plastic magnet-wrapper that can be otherwise attached to an eyeglass temple piece region.

FIG. 12 is a drawing showing three views (top, end, & side views) of one preferred shape of magnet#1 molded into a plastic magnet-wrapper that can be snapped-onto an eyeglass temple piece region. (The variations shown in FIGS. 7, 8 and 9 can be applied to this molded-on version, too.)

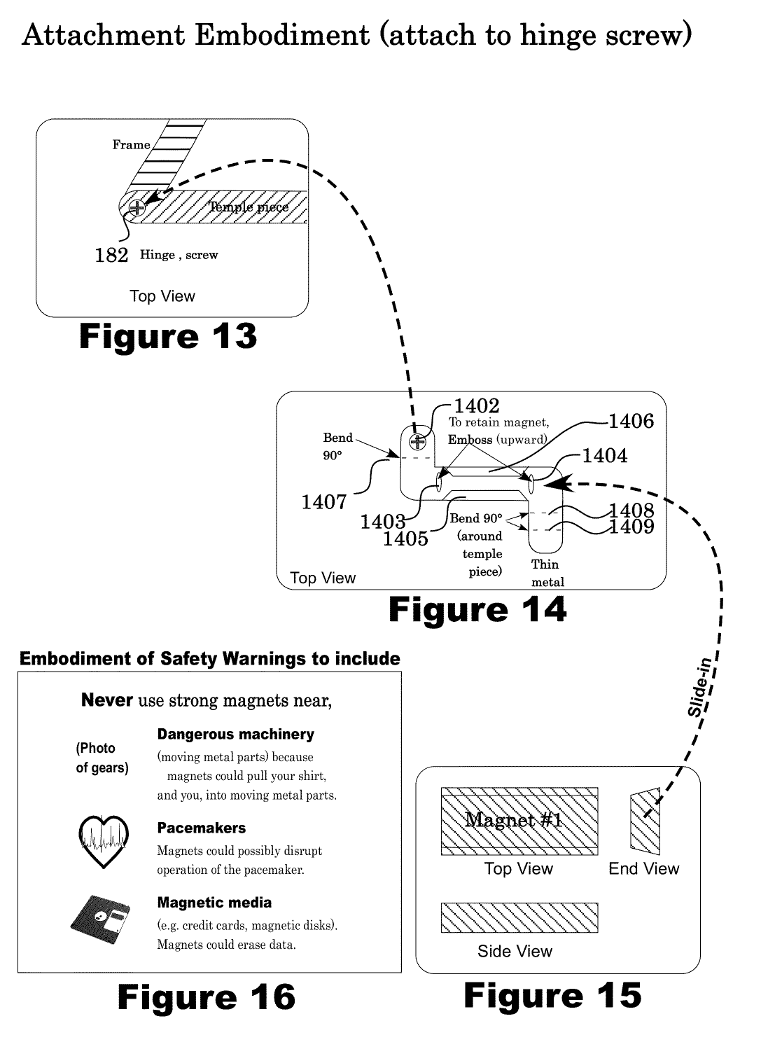

FIG. 13 is a drawing showing a top view of the hinge region of a pair of eyeglasses. A hinge screw 182 is shown. This figure helps explain FIG. 14.

FIG. 14 is a drawing showing a top view of the metal (or plastic) bracket that can be screwed into the threaded hinge hole of a pair of eyeglasses, by removing the original screw and replacing it (or a slightly longer screw) through the indicated hole 1402 in the bracket. The dashed lines 1407, 1408, and 1409 show places to bend the bracket, in order to place the magnet#1 (shown in FIG. 15) on the outside of the temple piece near the hinge. The two embossed bumps 1403 and 1404 keep magnet#1 within the bent up retaining wings 1405 and 1406. The lowest two dashed lines 1408 and 1409 in FIG. 14 illustrate how the bracket can be bent around the temple piece, further strengthening the attachment to the temple piece. Rounded (e.g. de-burred) edges and corners are essential to avoid discomfort to the user.

FIG. 15 is a drawing showing three views (top, end, & side views) of one preferred shape of magnet#1 with edges that can be captive in the magnet-wrapper which is shown in FIG. 14. This is identical to FIG. 6, and is repeated nearby FIG. 14 for convenient reference. The dashed arrow labeled “slide-in” is intended to show how magnet#1 can fit into the magnet-wrapper shown in FIG. 14.

FIG. 16 is an illustration showing safety warnings that should accompany retail sales of the present invention. In addition, “Caution: Small parts, swallowing hazard, keep away from children” should be included, too.

FIG. 17 is an illustration showing how to more easily separate strong magnets (e.g. magnet#2 from magnet#3). This simple drawing gets the point across, thereby making marketing more effective.

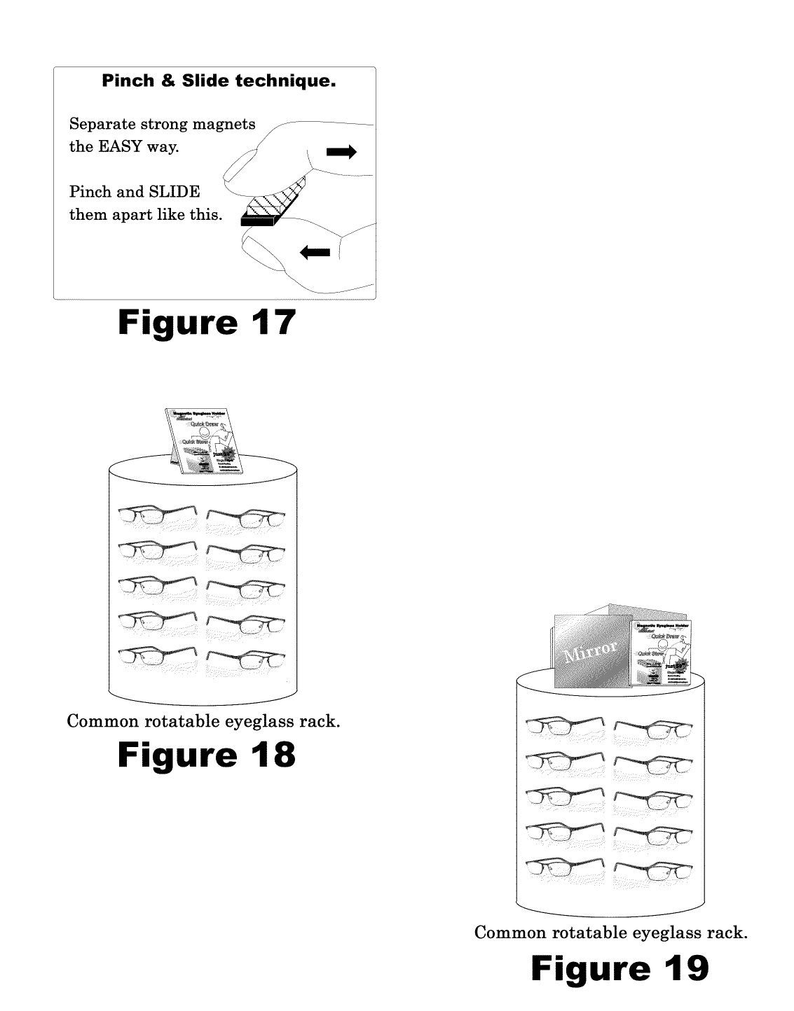

FIG. 18 is a perspective drawing showing a way of displaying the improved eyeglass holder (at a retail point-of-sale).

FIG. 19 is a perspective drawing showing a way of displaying the improved eyeglass holder along with a mirror(s) at a retail point-of-sale, (with which customers can inspect the looks of their new eyeglasses options). These higher quality mirrors can be an incentive to the retailer to place the eyeglass holder advertisement on top of existing rotary eyeglass display stands.

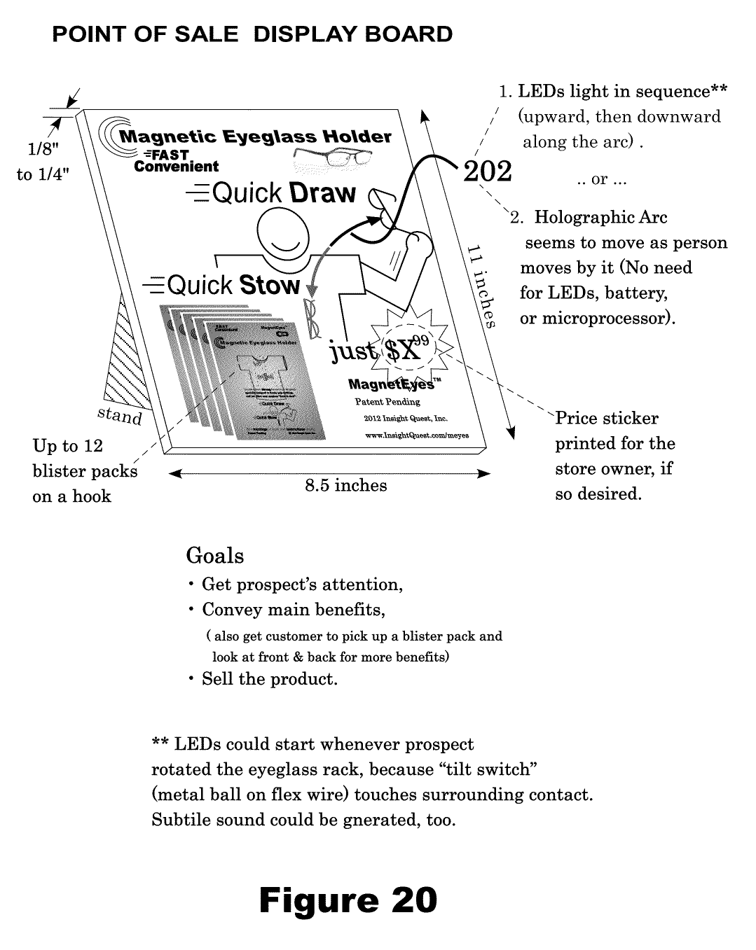

FIG. 20 is a perspective drawing showing one embodiment of a display board for selling the improved eyeglass holder. A subtle advantage (selling point) is the practical maintenance of eye contact (during a conversation), while eyeglasses are being fetched or stowed.

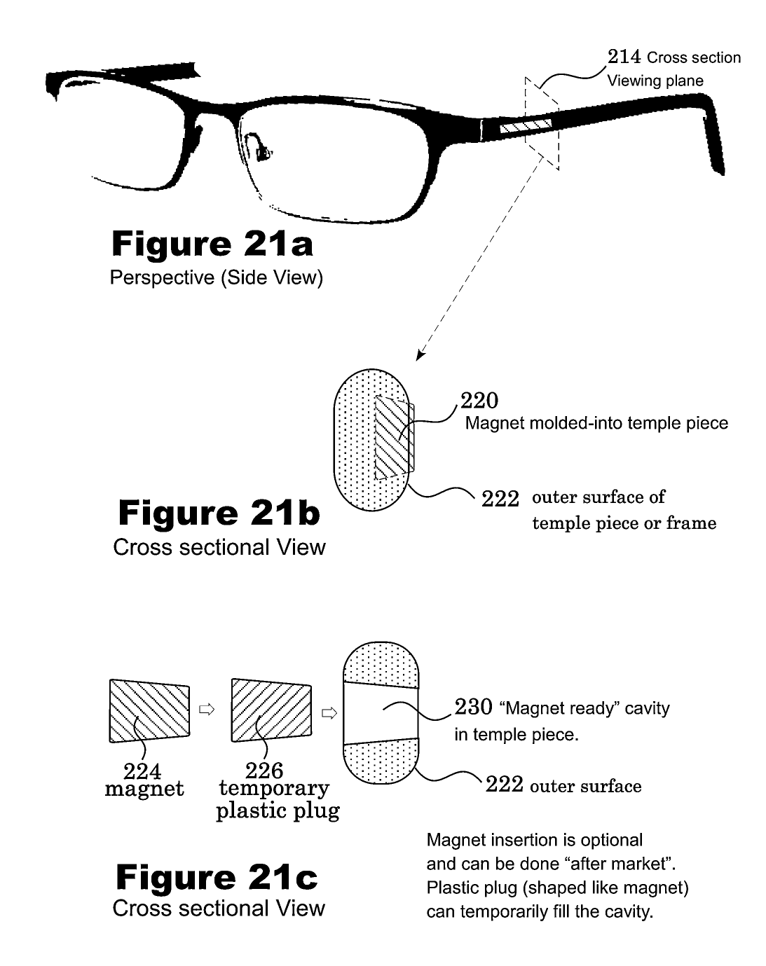

FIG. 21a is a perspective drawing of a pair of eyeglasses showing another magnet attachment approach. A cross section view plane is shown. This approach makes the heat-shrink tubing process unnecessary. It is for mass production. The cross section viewing plane 214 refers to what FIGS. 21b and 21c illustrate. (Of course, various other locations on the eyeglasses can work equally well).

FIG. 21b is a cross section drawing the temple piece showing a molded-in magnet. Here, the magnet is molded into the eyeglass temple piece or frame. High strength magnets can be somewhat expensive. This will add some base cost to the eyeglasses. Note that the magnet is exposed on the outside surface of the eyeglasses and that there is no heat-shrink tube wall thickness to separate magnet #1 from magnet#2. Therefore, this molded-in magnet #1 can be smaller (or magnetically weaker) that a magnet#1 separated from magnet#2 by heat-shrink tubing wall thickness (typically several thousands of an inch). In fact, an excessively strong attraction between magnet#1 and #2 can result in a undesired separation of magnets #2 and #3. The smaller magnet #1 can keep the temple piece physically strong, too.

Also, a slight variation on FIG. 21b, could allow insertion of a magnet from the outside of the temple piece and it would snap into a securely held position due to slightly compliant protrusions on the interior of the molded-in cavity (not shown in a drawing). Also, a variable magnetic gap (e.g. by using movable ramps/wedges) may be useful in order to optimize the ease of quick-draw vs. cloth-holding-strength.

FIG. 21c is a cross section drawing the temple piece showing a molded-in cavity, which can hold a low cost plastic plug or a magnet. Since high strength magnets can be somewhat expensive, the plastic plug option allows very high volume, low cost mass production, yet allows easy magnet attachment. Optionally, small detents can keep the magnet or plastic/metal plugs in place. (Note that most of the magnetic force will pull the magnet or plug even more securely into the cavity).

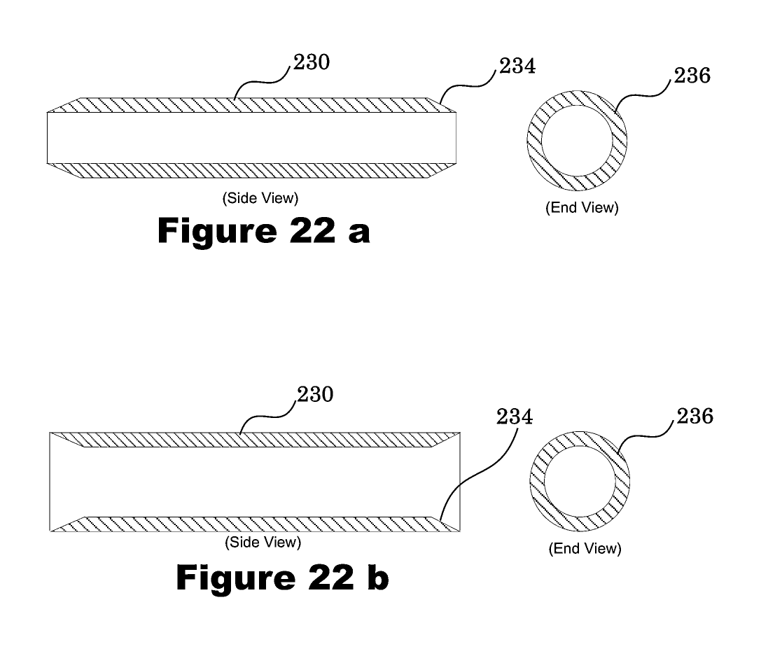

FIG. 22a is a side view and end view of a section of heat-shrink tubing 230 with removed sharp-irritating-edges by beveled edges 234. This is important and can require specialized tools to accomplish this beveled edge on such a thin (typically a few thousands of an inch) and less-than-rigid material, in a high volume, cost effective manner. (Note that some people might incorrectly think that beveling the edges might make the heat-shrink-tubing more irritating. However, the relatively high flexibility of the heat-shrink-tubing is such that beveling indeed makes it less irritating).

FIG. 22b is another side view and end view of a section of heat-shrink tubing 230 with removed sharp-irritating-edges by beveled edges 234. This is important and can require specialized tools to accomplish this beveled edge on such a thin (typically a few thousands of an inch) and less-than-rigid material, in a high volume, cost effective manner. Note that the tapers represented in FIG. 22a and in FIG. 22b are just two embodiments of a larger set that will successfully remove sharp-irritating-edges. All such variations are functionally equivalent, here.

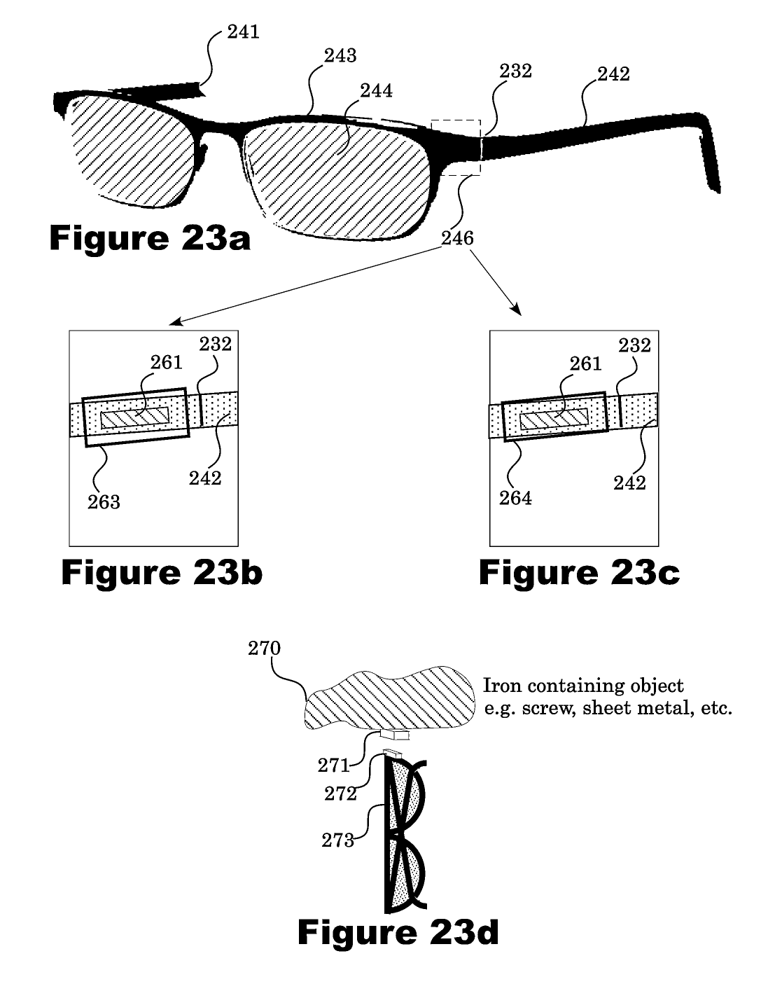

FIG. 23a is a perspective view of a pair of glasses (e.g. sunglasses) showing a region 246 between hinge and lens.

FIG. 23b is a perspective view of region 246 with magnet 261 and not-yet-shrunk heat-shrink-tubing 263.

FIG. 23c is a perspective view of region 246 with magnet 261 and already-shrunk heat-shrink-tubing 264.

FIG. 23d is a perspective view of a pair of glasses 273 with heats-shrink (or otherwise bonded) magnet 272 which is hanging by stronger magnet 271 which is magnetically (or otherwise) bonded to an iron-containing object 270 (such as a screw or sheet metal).

### Non-Obviousness:

After the foregoing disclosures, (i.e. with hindsight) some people might be tempted to say that this preferred embodiment of the present invention is obvious to the person of average skill average in the art. However, it is not obvious especially when one sees numerous different loop-based holders on the market that typically sell for about $15 each, despite their cost disadvantage from the requirement of at least one specially manufactured component (e.g. a loop and attachment). An embodiment of the present invention has an extreme sales advantage: Namely, no new manufacturing is needed! Three mass produced magnets can be purchased in volume, off the shelf, and a whole kit can be shipped in a very small blister pack for high profit margin and very low cost of entry.

Furthermore, an inexpensive kit like the present preferred embodiment of the present invention solves a crucial “chicken-and-the-egg problem”. That is, established eyeglass frame makers will not invest in thousands of new frame/temple-piece molds in order to mold-in magnets, until there is a large proven market. Only an inexpensive kit, for modifying ordinary mass produced eyeglasses, can develop a large proven market.

Moreover, one can use the present embodiment to clearly see and experience the significant improvements, as have friends of the author. Also non-obvious, is the precise balancing of magnetic bond strength (strong enough between magnets #2 and #3 to grasp clothing without slipping and weak enough to be removed when necessary, and weaker but adequate magnetic bond strength between magnet s #1 and #2, allowing easy quick draw, yet secure bond during jogging and running. In some embodiments, the thickness of heat-shrink tubing acts to increase the magnetic gap by just the right amount (e.g. when magnet#2 and magnet#3 are the same size and strength).

Also, cost effective, high strength-to-size ratio neodymium magnets have only recently become widely available, making the present embodiment the first practical embodiment of its kind.

Another unobvious aspect: Things that people visibly wear need to meet their aesthetic standards. An embodiment of the present invention includes one or more symbols, artworks or images which can artfully personalize magnet#2, which looks clean (no loop) and as artful as a lapel pin (like a US flag), and still provides the other benefits of quick-draw and quick-stow eyeglass holders.

Thus, this Preferred Embodiment of the Present Invention is Clearly not Obvious.

Thus, a Quick Draw and Quick Stow Magnetic Eyeglass Holder has been disclosed in extensive detail. It should be understood that innovations disclosed herein can be more generally applied than explicitly stated. To the extent that such variations do not depart from the spirit of the invention, they are intended to be included within the scope thereof which is assessed only by a fair interpretation of the following claims.

I claim:

1. An embodiment of a magnetic eyeglasses holder system including a kit which eyeglasses users can use to substantially permanent modify their ordinary eyeglasses including a first magnet with a means for substantially permanent attachment of said first magnet to a temple piece or a frame of said eyeglasses.

2. An embodiment of an improved magnetic eyeglasses holder system including,
a. a first magnet with a means for substantially permanent attachment of said first magnet to a temple piece or a frame of said eyeglasses,
b. a second magnet which can be positioned outside an article of clothing,
c. a third magnet that can be positioned inside said article of clothing nearby said second magnet,
d. wherein, a resulting magnetic attractive force between said second magnet and said third magnet can securely grip said article of clothing,
e. wherein, said resulting magnetic attractive force between said second magnet and said third magnet, substantially exceeds the resulting magnetic attractive force between said second magnet and said first magnet.

3. The embodiment of the improved magnetic eyeglasses holder system of claim 2, wherein said means for substantially permanent attachment includes heat shrink tubing that can surround both said first magnet and a first segment, or a second segment, of a temple piece of said eyeglasses, wherein, subsequent heating can cause shrinkage resulting in substantially permanent attachment.

4. The embodiment of the improved magnetic eyeglasses holder system of claim 3, further including
a. an adhesive with a first adhesive surface for bonding to said first magnet,
b. a second adhesive surface temporarily covered by a removable liner, for eventual bonding to said eyeglasses.

5. The embodiment of an improved magnetic eyeglasses holder system of claim 3, wherein
a. said eyeglasses possess substantially strong hinge springs capable of remaining substantially closed once closed,
b. wherein, said first segment is located substantially within 1 inch of the tip of said temple piece.

6. The embodiment of an improved magnetic eyeglasses holder system of claim 3, wherein
a. said eyeglasses might not possess substantially strong enough hinge springs capable of remaining substantially closed once closed,
b. wherein, said second segment is located substantially within 1 inch of at least one hinge of said eyeglasses.

7. The embodiment of an improved magnetic eyeglasses holder system of claim 2, wherein said means for substantially permanent attachment includes a metal or plastic bracket that grips said first magnet and can be fastened by a screw into a hinge screw hole in said eyeglasses.

8. The embodiment of an improved magnetic eyeglasses holder system of claim 2, wherein
a. said means for substantially permanent attachment includes a magnet wrapper
b. wherein, said magnet wrapper attaches to said eyeglasses and grips said first magnet.

9. The embodiment of an improved magnetic eyeglasses holder system of claim 8, wherein
a. said first magnet and said wrapper both have substantially similar sloping sides which can interlock when said first magnet is slid into said wrapper,
b. wherein, a retaining pin can be added to prevent said first magnet from sliding out.

10. The embodiment of an improved magnetic eyeglasses holder system of claim 8, wherein
a. said first magnet and said wrapper both have substantially similar sloping sides which can interlock when said first magnet is slid into said wrapper,
b. wherein, said wrapper has a substantially hollow region that can be snapped onto or clipped around a first segment, or a second segment, of said temple piece.

11. The embodiment of an improved magnetic eyeglasses holder system of claim 10, further including a retaining shim to further secure said substantially hollow region to said first segment, or to said second segment, of said temple piece.

12. The embodiment of an improved magnetic eyeglasses holder system of claim 8, wherein
a. said first magnet has at least one substantially sloped side which can be securely embedded into a molded or over molded magnet wrapper,
b. wherein, said molded or over molded magnet wrapper can be bonded to said eyeglasses.

13. The embodiment of an improved magnetic eyeglasses holder system of claim 8, wherein
a. said first magnet has at least one substantially sloped side which can be securely embedded into a molded or over molded magnet wrapper,
b. wherein, said molded or over molded magnet wrapper has a substantially hollow region that can be snapped onto or clipped around a first segment, or a second segment, of said temple piece.

14. The embodiment of an improved magnetic eyeglasses holder system of claim 13, further including a retaining shim to further secure said molded or over molded magnet wrapper to said first segment, or to said second segment, of said temple piece.

15. The embodiment of the improved magnetic eyeglasses holder system of claim 2, wherein said means for substantially permanent attachment includes molding or over molding said first magnet into a first segment, or a second segment, of said temple piece of said eyeglasses.

16. The embodiment of the improved magnetic eyeglasses holder system of claim 2, wherein said means for substantially permanent attachment includes molding or over molding a substantially recessed region into a first segment, or a second segment, of said temple piece of said eyeglasses, wherein, a removable plug can temporarily fill said recessed region, wherein said removable plug can be subsequently replaced with said first magnet.

17. The embodiment of an improved magnetic eyeglasses holder system of claim 3, wherein said heat shrink tubing has substantially reduced edge sharpness or substantially reduced edge stiffness, thereby substantially reducing possible skin irritation.

18. The embodiment of an improved magnetic eyeglasses holder system of claim 2, wherein said second magnet is decorated with one or more symbols, artworks or images.

19. The embodiment of an improved magnetic eyeglasses holder system of claim 2, wherein said eyeglasses can be temporarily magnetically fastened via said first magnet to another magnet which is magnetically or otherwise bonded to an iron containing object.

20. A method for adapting ordinary eyeglasses for quick draw and quick stow, comprising:
a. providing a kit of at least three magnets with heat shrink tubing, instructions and warnings,
b. printing one or more substantially personalized images on one or more of said magnets,
c. selling said kit online or in brick and mortar stores.
